(19) United States
(12) Patent Application Publication
(10) Pub. No.: US 2005/0197838 A1
(43) Pub. Date: Sep. 8, 2005

(54) Method for text-to-pronunciation conversion capable of increasing the accuracy by re-scoring graphemes likely to be tagged erroneously

(75) Inventors: Yi-Chung Lin, Keelung City (TW); Peng-Hsiang Hung, Kaohsiung City (TW); Ren-Jr Wang, Taipei-City (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu (TW)

(21) Appl. No.: 10/900,101

(22) Filed: Jul. 28, 2004

(30) Foreign Application Priority Data
Mar. 5, 2004 (TW) 093105860

(51) Int. Cl. G10L 13/00

(52) U.S. Cl. 704/260

(57) ABSTRACT

The present invention provides a method for text-to-pronunciation conversion capable of increasing the accuracy by re-scoring graphemes likely to be tagged erroneously. Grapheme segmentation and phoneme tagging are first applied to an input word to generate at least one grapheme-phoneme pair sequence, and the score of each grapheme-phoneme pair sequence is also computed. Then, at least one grapheme-phoneme pair sequence having a higher score is selected. For the selected grapheme-phoneme pair sequence that has a grapheme likely to be tagged erroneously, the features in the context of the grapheme are selected and made good use of computing re-score corresponding to the graphemes likely to be tagged erroneously, so as to re-score the grapheme-phoneme pair sequence. Accordingly, the grapheme-phoneme pair sequence with the highest score is the final conversion result.

### BACKGROUND OF THE INVENTION

1. Field of the Invention

The present invention relates to a method for text-to-pronunciation conversion and, more particularly, to a method for text-to-pronunciation conversion capable of increasing the accuracy by re-scoring graphemes likely to be tagged erroneously.

2. Description of the Related Art

Text-to-pronunciation conversion converts input text into output pronunciation, and is often used for speech synthesis and speech recognition-related systems. In fact, the best way to obtain the pronunciation of text is by looking into a dictionary. However, the typical dictionary will not cover all text words and pronunciations, and so the speech system may need a text-to-pronunciation conversion technique to generate the pronunciation for the text that is not collected within the dictionary. For speech synthesis, this text-to-pronunciation conversion technique provides the pronunciation for text to avoid speech output (out of vocabulary) problems. For speech recognition systems, to increase recognition accuracy, the system adds new text to extend its database, and the text-to-pronunciation conversion technique is used to process the new text. Speech is a very important medium for human-machine interfaces, and the text-to-pronunciation conversion technique plays a very important role in both speech synthesis and speech recognition.

The traditional strategy used for text-to-pronunciation conversion is rule-based, which requires phonological rules to be written by a language expert. However, these rules can not cover all conditions, and in any case, by adding new rules, the possibility increases for a new rule to contradict an existing rule. As more new rules are added, modification and maintenance costs increase. Furthermore, as these rules differ for different languages, to transfer the field of application to other languages, a huge amount of time and human resources is required to establish new rules. Therefore, rule-based text-to-pronunciation conversion techniques lack reusability and portability, and their efficiency is difficult to be improved.

Due to the above-mentioned shortcomings, more and more text-to-pronunciation conversion systems use data-driven methods, which include pronunciation by analogy (PbA), neural-networks, decision trees, joint N-gram modules and automatic rule learning procedures. All of these methods require speech training materials, which are usually a dictionary that includes text and correspond pronunciation. The advantage of a data-driven method is that it does not require huge human resources and professional expertise, and can be applied to different languages. Therefore, data-driven methods are better than rule-based methods. Among the data-driven methods, PbA and joint N-gram modules are two of the more popular methods.

The PbA method separates the input text into graphemes with different lengths, and then compares these graphemes with the text stored in the dictionary to find the best phoneme for each grapheme, and establish the grapheme and phoneme as a graph. The best path in the graph represents the pronunciation for the input text. The joint N-gram module method separates the input text and pronunciation into grapheme-phoneme pairs, and then uses these pairs to establish a probability network. The subsequent input text is separated into grapheme-phoneme pairs, and the built up probability network is used to find the best phoneme sequence. Currently, the joint N-gram module has a higher accuracy, but takes a longer time to finish the conversion. The PbA method is more efficiently, but has a lower accuracy than the joint N-gram module.

Therefore, it is desirable to provide a method for text-to-pronunciation conversion capable of increasing the accuracy by re-scoring graphemes likely to be tagged erroneously to mitigate and/or obviate the aforementioned problems.

### SUMMARY OF THE INVENTION

A main objective of the present invention is to provide a method for text-to-pronunciation conversion capable of increasing the accuracy by re-scoring graphemes likely to be tagged erroneously, which provides highly accurate text-to-pronunciation conversion in a short amount of time.

In order to achieve the above mentioned objective, the text-to-pronunciation conversion method includes: applying grapheme segmentation and phoneme tagging to an input word to generate at least one grapheme-phoneme pair sequence, every grapheme-phoneme pair sequence comprising at least one grapheme and a corresponding phoneme, and computing a score of each grapheme-phoneme pair sequence; and re-scoring a grapheme-phoneme pair sequence that has a grapheme likely to be tagged erroneously from the at least one grapheme-phoneme pair sequence having a higher score, features in a context of the grapheme being selected and utilized for computing a connection between the features and phoneme corresponding to the grapheme likely to be tagged erroneously thereby re-scoring the grapheme-phoneme pair sequence, and accordingly, using the grapheme-phoneme pair sequence with the highest score as a final conversion result.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a method according to the present invention for text-to-pronunciation conversion capable of increasing the accuracy by re-scoring graphemes likely to be tagged erroneously.

FIG. 2 is a graph built up by the method of the present invention.

FIG. 3 shows accuracy obtained by the method of the present invention.

### DETAILED DESCRIPTION OF THE PREFERRED EMBODIMENT

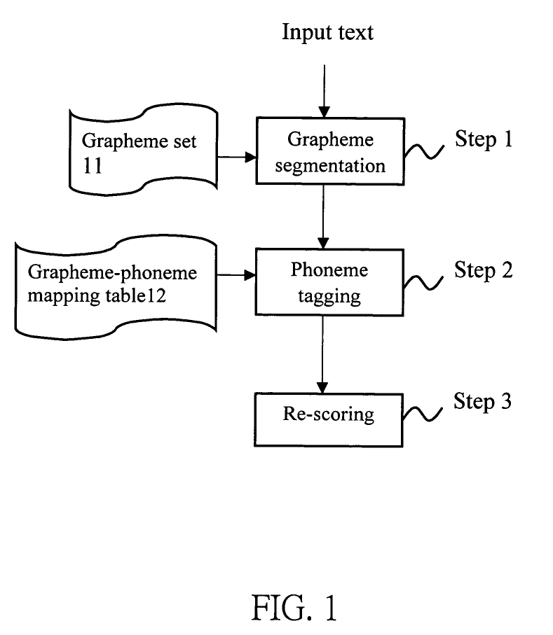

Please refer to FIG. 1. FIG. 1 is a flowchart of a method according to the present invention for text-to-pronunciation conversion capable of increasing the accuracy by re-scoring graphemes likely to be tagged erroneously. The method utilizes a grapheme set 11 and a grapheme-phoneme mapping table 12 to perform a text-to-pronunciation conversion. First, grapheme segmentation is performed to input text (step 1) to obtain at least one grapheme sequence. The input text utilizes roman-spelling, or similar text such as English, German, French, etc. Next, phoneme tagging is performed to the grapheme sequence with higher accuracy (step 2) to obtain a phoneme sequence to generate a grapheme-phoneme pair sequence. Finally, additional features are added into the graphemes likely to be tagged erroneously, and then a re-scoring is performed (step 3).

In step 1, an N-gram module is used to perform the grapheme segmentation, which is performed to the input text, according to the graphemes included in the grapheme set 11, to obtain at least one grapheme sequence G=(g₁g₂ . . . gᵢ . . . gₙ), where gi is a grapheme. For example, if the input text is “feasible”, the grapheme set 11 is {a, b, e, ea, f, i, s, le, . . . }, and the possible grapheme sequence can be “f-e-a-s-i-b-le” or “f-ea-s-i-b-le”. For every grapheme sequence, its score S_{G} can be obtained by the following:

$${S}_{G} = {\sum }_{i = 1}^{n} log ( P ( {g}_{i} \vert {g}_{i - N + 1}^{i - 1} ) ) ,$$

where n is the number of graphemes included in the grapheme sequence, N denotes the N of the N-gram module, which is also the number of graphemes before gᵢ used for determining the score of gᵢ.

In step 2, phoneme tagging is performed to the grapheme sequence with a higher score generated by step 1 according to the grapheme-phoneme mapping table 12 between the grapheme and phoneme. In the grapheme-phoneme mapping table 12, more than two phonemes correspond to every grapheme, sometimes more than ten phonemes, and therefore, every grapheme sequence can provide at least one phoneme sequence P=(f₁f₂ . . . fᵢ . . . fₙ), wherein fᵢ is a phoneme. In order to find the best phoneme sequence, a score S_{P} of every phoneme sequence can be obtained by the following:

$${S}_{P} = {\sum }_{i = 1}^{n} log ( P ( {f}_{i} \vert {g}_{i - R}^{i - L} ) ) ,$$

where L, R are two ranges of a previous and following context of the grapheme, n is the number of phonemes included in the phoneme sequence, and gᵢ presents a corresponding grapheme of fᵢ. Furthermore, at least one phoneme sequence with a higher score is selected from the corresponding phoneme sequences of every grapheme sequence to generate a grapheme-phoneme pair sequence.

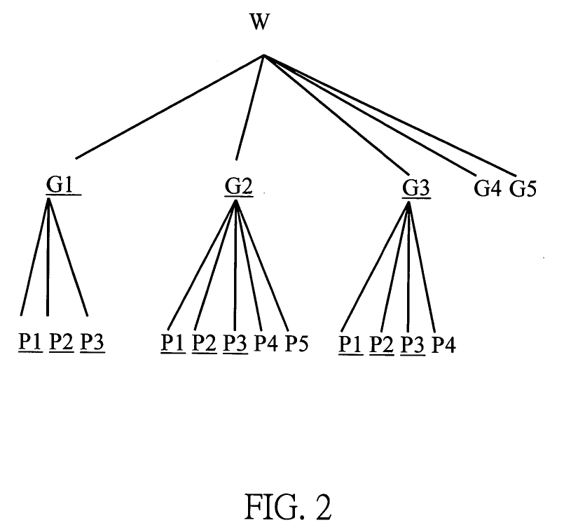

Based on step 1 and step 2, a graph is built up; as shown in FIG. 2, a plurality of grapheme sequences G1˜G5 are obtained by performing the grapheme segmentation to input text W. The grapheme sequences G1˜G3 with higher scores are selected from the plurality of grapheme sequences G1˜G5. In step 2, a plurality of phoneme sequences P1˜P3, P1˜P5, P1˜P4 are indicated for every selected grapheme sequences G1˜G3, and n (in this embodiment n=3) phoneme sequences with higher scores P1˜P3, P1˜P3, P1˜P3, to generate grapheme-phoneme pair sequences G1P1, G1P2, G1P3, G2P1, G2P2, G2P3, G3P1, G3P2, G3P3. Therefore, a graph is built up according to the above grapheme-phoneme pair sequences. Furthermore, in step 2, the grapheme sequences are determined, and thus the graph is built up by the phoneme sequences. Compared to another graph built up by the grapheme-phoneme pair sequences obtained by the joint N-gram module method, this graph is smaller, which requires less processing time.

Every grapheme-phoneme pair in the above graph is a possible text-to-pronunciation conversion; their scores are weight adjusted according to the grapheme sequence scores and the phoneme sequence scores as follows to obtain a score S_{G2P} of text-to-pronunciation conversion:
S_{G2P}=w_{G}S_{G}+w_{P}S_{P},
where S_{G} is a score of the grapheme sequence, S_{P} is a score of the phoneme sequence, and W_{G} and W_{P} are weight values for the scores S_{G} and score S_{P}.

Taking the grapheme-phoneme pair sequence with the highest score as a conversion result, when L=1, R=2, the word accuracy is 59.71%, which exceeds the average result of 58.54% for the PbA method. However, in the grapheme-phoneme pair sequence generated by step 1 and step 2, since some graphemes have more corresponding phonemes, previous and following graphemes provided as features do not provide sufficient information for correct pronunciation determination. The graphemes likely to be tagged erroneously occur most frequently in vowels (such as a, e, i, o, u); the average number of phonemes corresponding to each vowel is 10.6, which may lead to an error in pronunciation determination, and thus affect the accuracy.

In order to ensure correct graphemes for the vowels, in step 3, for the grapheme-phoneme pair sequences with higher scores generated by step 1 and step 2, more features are added into the graphemes likely to be tagged erroneously, and a weighted adjustment is performed to obtain a grapheme-phoneme pair sequence as a result.

In step 3, in n (n being a positive integer) grapheme-phoneme pair sequences with higher scores generated by step 2, for the grapheme-phoneme pair sequences having graphemes likely to be tagged erroneously, the features (may include the graphemes as well as the phoneme and grapheme-phoneme pair) of the context are selected based on every grapheme likely to be tagged erroneously to obtain the score in step 3. In this embodiment, mutual information (MI) is used to calculate the connection between these features and the phoneme corresponding to the grapheme likely to be tagged erroneously. The mutual information indicates a possibility of the features and the phoneme corresponding to the grapheme likely to be tagged erroneously showing together, and then a re-scoring is performed to the grapheme-phoneme pair sequences as follows:

$${S}_{R} = {{\sum }_{i}}_{{g}_{i} ∈ E} {\sum }_{j = 1}^{\vert X ( i ) \vert} {w}_{j} log ( \frac{P ( {x}_{j} , {f}_{i} )}{P ( {x}_{j} ) P ( {f}_{i} )} ) \times \frac{1}{{{\sum }_{i}}_{{g}_{i} ∈ E} 1}$$

where, wⱼ is a weight value, E is a set of graphemes likely to be tagged erroneously (in this embodiment only vowels need to be rescored), X(i) is a set of selected features, which can be obtained by:

$$\begin{matrix}X ( i ) = {{⋃}_{n = 1}}^{N} {X}_{n} ( i ; g ) ⋓ {{⋃}_{n = 1}}^{N} {X}_{n} ( i ; f ) ⋓ {{⋃}_{n = 1}}^{N} {X}_{n} ( i ; τ ) \\ {X}_{n} ( i ; y ) = \{ x \vert x = {y}_{l} … {y}_{r} , i - L \leq l \leq r \leq i + R ⋀ ( r - l + 1 ) \\ = n ⋀ i ∉ [ l , r ] \} \\ ⋓ \{ x \vert x = {y}_{l} … {y}_{i - 1} {y}_{i + 1} … {y}_{r} , \\ i - L \leq l \leq r \leq i + R ⋀ ( r - l + 1 ) \\ = n ⋀ i ∈ [ l , r ] \}\end{matrix}$$

where τᵢ≡gᵢfᵢ, L and R represent a range of the context of the grapheme gᵢ, N is a number of selected grapheme-phoneme sequences having higher scores, y is g, f or τ, l and r represent the position that y appears, which needs to be between i-L and i+R.

After re-scoring n grapheme-phoneme pair sequences with higher scores, a re-scored score S_{R} of every grapheme-phoneme pair sequence is obtained. Finally, the weight adjustment and the score S_{G2P} are combined to obtain a final score S_{Final}:
S_{Final}=w_{G2P}S_{G2P}+w_{R}S_{R},
where a grapheme-phoneme pair sequence with the highest score is the result.

In order to prove the outstanding results of the present invention, a CMU (Carnegie Mellon University) pronunciation dictionary (http://www.speech.cs.cmu.edu/cgi-bin/cmudict) is used for verification. The CMU pronunciation dictionary is a machine-readable dictionary, which includes over 125,000 English words and corresponding pronunciations. These pronunciations are composed of a phoneme set including 39 phonemes. After taking out punctuation marks and words with multiple pronunciations, 110,327 words remain. Now, all graphemes G(w)=g₁g₂ . . . gₙ of each word w and corresponding phonemes P(w)=f₁f₂ . . . fₘ are both matched up by an automatic module to obtain a plurality of grapheme-phoneme pair sequences GP(w)=g₁p₁:g₂p₂: . . . gₙpₘ. Afterward, all-grapheme-phoneme pair sequences are randomly divided into ten sets, and then cross-validation is performed for an experimental evaluation.

The experimental evaluation first performs the grapheme segmentation to the input text, according to a result, the first two grapheme sequences with higher scores S_{G} has a correct including rate of 98.25%, which is much higher than the correct inclusion rate of 90.61% obtained by just selecting the highest score S_{G}. Now, phoneme tagging is performed according to the two grapheme sequences with higher scores S_{G}; the phoneme tagging is performed based on previous and following graphemes, its ranges are L=1, R=2, and then the first twenty phoneme sequences with higher scores S_{P} are selected for every grapheme sequence. Afterward, the first twenty grapheme-phoneme pair sequences with higher scores S_{G2P} are selected according to the scores S_{G} of the grapheme sequences and the scores S_{P} of the phoneme sequences, obtaining a word accuracy of 59.71%, which is higher than the word accuracy of 59.63% obtained by just selecting the grapheme sequence with the highest score S_{G} and first twenty phoneme sequences with higher scores S_{P}. Additionally, the correct inclusion rate of 90.95% is also much higher than the correct inclusion rate 88.92% obtained by just selecting the first twenty phoneme sequences with higher scores S_{P}.

Finally, a re-scoring is performed to the vowels (a, e, i, o, u), by adding more features (previous and following phonemes, grapheme and grapheme-phoneme pair sequences) and extending the range from L=1, R=2 to L=5, R=5, and a vowel verification is performed according to the first twenty grapheme-phoneme pair sequences with higher scores S_{G2P} to obtain the re-scored scores S_{R}.

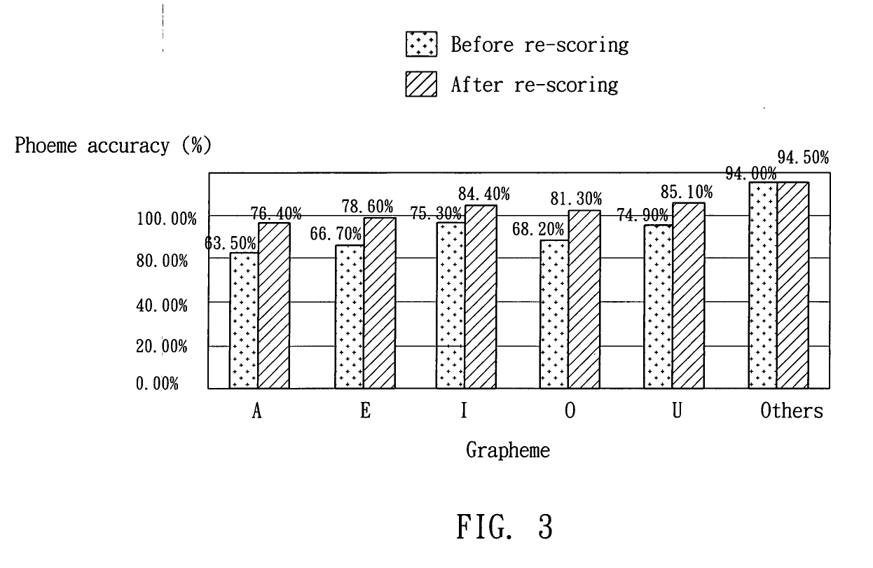

According to the experimental results, the word accuracy is raised from 59.71% to 69.13%, yielding an error reduction rate of 23.38%, and also exceeds the joint N-gram module word accuracy of 67.89% (N=4). For a further analysis, as shown in FIG. 3, the average accuracy of vowel phonemes is also raised from 69.72% to 81.16%, with an error reduction rate of 37.78%. Consequently, the method of the present invention can improve the accuracy of text-to-pronunciation conversion.

Although the present invention has been explained in relation to its preferred embodiment, it is to be understood that many other possible modifications and variations can be made without departing from the spirit and scope of the invention as hereinafter claimed.

1. A method for text-to-pronunciation conversion capable of increasing the accuracy by re-scoring graphemes likely to be tagged erroneously, the method comprising:
applying grapheme segmentation and phoneme tagging to an input word to generate at least one grapheme-phoneme pair sequence, every grapheme-phoneme pair sequence comprising at least one grapheme and a corresponding phoneme, and computing a score of each grapheme-phoneme pair sequence; and
re-scoring a grapheme-phoneme pair sequence that has a grapheme likely to be tagged erroneously from the at least one grapheme-phoneme pair sequence having a higher score, features in a context of the grapheme being selected and utilized for computing a connection between the features and phoneme corresponding to the grapheme likely to be tagged erroneously thereby re-scoring the grapheme-phoneme pair sequence, and accordingly, using the grapheme-phoneme pair sequence with the highest score as a final conversion result.

2. The method as claimed in claim 1, wherein the connection between the features and phoneme corresponding to the grapheme likely to be tagged erroneously is computed by mutual information.

3. The method as claimed in claim 1, wherein the generation of the grapheme-phoneme pair sequence comprises:
applying the grapheme segmentation to the input word according to graphemes stored in a predetermined grapheme set to obtain at least one grapheme sequence and a corresponding score, every grapheme sequence comprising a plurality of graphemes;
applying phoneme tagging to at least one grapheme sequence having a higher score according to a predetermined mapping between the grapheme and the phoneme to obtain at least one phoneme sequence for every grapheme sequence and a score for every phoneme sequence, and then selecting at least one phoneme sequence having a higher score to generate at least one grapheme-phoneme pair sequence.

4. The method as claimed in claim 2, wherein every grapheme-phoneme pair sequence is re-scored to have a score as:
$${S}_{R} = {{\sum }_{i}}_{{g}_{i} ∈ E} {\sum }_{j = 1}^{\vert X ( i ) \vert} {w}_{j} log ( \frac{P ( {x}_{j} , {f}_{i} )}{P ( {x}_{j} ) P ( {f}_{i} )} ) \times \frac{1}{{{\sum }_{i}}_{{g}_{i} ∈ E} 1}$$
where gᵢ is a grapheme of the grapheme sequence, fᵢ is a phoneme of the phoneme sequence, wⱼ is a weight value, E is a set of graphemes likely to be tagged erroneously, X(i) is a set of selected features, xⱼ represents any one feature in the feature set X(i).

5. The method as claimed in claim 4, wherein X(i) is:
$$\begin{matrix}X ( i ) = {{⋃}_{n = 1}}^{N} {X}_{n} ( i ; g ) ⋓ {{⋃}_{n = 1}}^{N} {X}_{n} ( i ; f ) ⋓ {{⋃}_{n = 1}}^{N} {X}_{n} ( i ; τ ) \\ {X}_{n} ( i ; y ) = \{ x \vert x = {y}_{l} … {y}_{r} , i - L \leq l \leq r \leq i + R ⋀ ( r - l + 1 ) \\ = n ⋀ i ∉ [ l , r ] \} \\ ⋓ \{ x \vert x = {y}_{l} … {y}_{i - 1} {y}_{i + 1} … {y}_{r} , \\ i - L \leq l \leq r \leq i + R ⋀ ( r - l + 1 ) \\ = n ⋀ i ∈ [ l , r ] \}\end{matrix}$$
where τᵢ≡gᵢfᵢ, L and R represent a range of a context of the grapheme gᵢ, N is a number of selected grapheme-phoneme pair sequences having higher scores, y is g, f or τ, and l and r represent the position of y that needs to be between i−L and i+R.

6. The method as claimed in claim 3 wherein a score S_{G2P} of every grapheme-phoneme pair sequence is:
S_{G2P}=w_{G}S_{G}+w_{P}S_{P},
where S_{G} is a score of the grapheme sequence, S_{P} is a score of the phoneme sequence, and W_{G} and W_{P} are weight values.

7. The method as claimed in claim 6, wherein in the grapheme segmentation, an obtained score S_{G} of every grapheme sequence is:
$${S}_{G} = {\sum }_{i = 1}^{n} log ( P ( {g}_{i} \vert {g}_{i - N + 1}^{i - 1} ) ) ,$$
where gᵢ is a grapheme of the grapheme sequence, n is a number of graphemes included in the grapheme sequence, N is a score of gᵢ decided by N graphemes before gᵢ.

8. The method as claimed in claim 6, wherein in the phoneme tagging, an obtained score S_{P} of every phoneme sequence is:
$${S}_{P} = {\sum }_{i = 1}^{n} log ( P ( {f}_{i} \vert {g}_{i - R}^{i - L} ) ) ,$$
where fᵢ is a phoneme of the phoneme sequence, L and R represent two ranges of a context of the grapheme gᵢ, and n is a number of phonemes included in the phoneme sequence.

9. The method as claimed in claim 4, wherein in re-scoring, a re-scored score S_{Final} of every grapheme-phoneme pair sequence is:
S_{Final}=w_{G2P}S_{G2P}+w_{R}S_{R},
where W_{G2P} and W_{R} are weight values.

10. The method as claimed in claim 1, wherein the input word is Romanic text.

11. The method as claimed in claim 1, wherein the graphemes likely to be tagged erroneously are vowels in English.

12. The method as claimed in claim 1, wherein the features in the context include phoneme, grapheme and grapheme-phoneme pair.

13. The method as claimed in claim 3, wherein in the phoneme tagging, every grapheme corresponds to at least one phoneme.

14. The method as claimed in claim 3, wherein in the grapheme segmentation, an N-gram module is used to perform the grapheme segmentation to the input text.
